(19) United States
(12) Patent Application Publication
(10) Pub. No.: US 2009/0281701 A1
(43) Pub. Date: Nov. 12, 2009

(54) MULTI-MODE ACCELERATOR FOR AUTOMOBILE AND METHOD

(76) Inventor: James B. Kargman, Chicago, IL (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/437,206

(22) Filed: May 7, 2009

Related U.S. Application Data
(60) Provisional application No. 61/051,061, filed on May 7, 2008.

(51) Int. Cl. G06F 19/00

(52) U.S. Cl. 701/70

(57) ABSTRACT

An accelerator pedal for an automobile, truck or other vehicle has three ranges of motion corresponding to three operating zones or modes of the vehicle. Moving the accelerator to the first range of motion maintains the vehicle at a constant speed as a first zone or mode of operation. Moving the accelerator pedal to the second range of motion provides a controlled gradual acceleration of the vehicle in a fuel efficient manner. This second zone or mode of operation is controlled by a computer control. Moving the accelerator to the third range of motion changes the operating mode of the vehicle to the third zone which provides normal operation of the accelerator to control the speed of the vehicle. Indicators may be provided to the driver to indicate the operating mode. An indicator may be provided on the rear of the vehicle to indicate operating mode to other drivers. The accelerator control may be added as a retrofit to existing vehicles or provided as factory equipment on new vehicles.

### CROSS-REFERENCE TO RELATED APPLICATION

This application claims the benefit of U.S. Provisional Patent Application Ser. No. 61/051,061, filed May 7, 2008, which is incorporated herein by reference.

### BACKGROUND OF THE INVENTION

1. Field of the Invention

The present invention relates generally to an accelerator for an automobile or other vehicle and to a method for operating an accelerator, and in particular to an accelerator pedal and acceleration controller for providing controlled acceleration of the vehicle.

2. Description of the Related Art

Automobiles, trucks, vans and other motorized vehicles currently run predominantly on gasoline or diesel fuel powered engines, although gasoline-electric hybrid vehicles, natural gas vehicles, and electric vehicles are becoming increasingly available. The quantity of fuel consumed by a vehicle depends on a number of factors, including vehicle size and mass, engine efficiency, tire friction, wind resistance, etc. Most of these factors are not variable to any great extent by the user of the vehicle, at least not without modification of the vehicle or exchanging the vehicle for another vehicle. One factor effecting fuel efficiency of the vehicle is the rate at which the driver accelerates, while another is the extent to which the drive varies the acceleration or speed during vehicle operation. It would be an improvement to provide an apparatus to assist a driver in controlling vehicle acceleration and variations in acceleration. Use of the accelerator pedal as a control or signaling device controlled by the driver goes back to the 1950's and the “semi-automatic” transmission. With this mechanism, drivers could control the shift timing of the transmission. To do this they would accelerate by pressing on the gas pedal, and then as the engine RPM's increased and the engine reached the desired shift point, by removing the pressure on the pedal, the transmission would sense the reduction in load coming from the engine, and this would trigger a shift to the next higher gear.

### SUMMARY OF THE INVENTION

The present invention provides an accelerator apparatus for an automobile that provides distinct operating zones or modes for the operation of the automobile. The apparatus provides feedback to the driver of the automobile to indicate in which of the operating zones the vehicle is operating. The operating zones correspond to differing fuel efficiency for the operation of the vehicle. In at least one of the operating zones, the acceleration of the vehicle is controlled by a computer to provide acceleration at a lower fuel consumption rate.

In the preferred embodiment, the accelerator pedal of an automobile has three distinct zones or ranges of motion. In a first zone, the vehicle is operated by computer control to maintain a predetermined speed. Once the driver or operator of the vehicle has reached a desired speed, the accelerator pedal is moved to and kept in the first zone and a control maintains the desired speed. Generally, the accelerator pedal has been used to bring the vehicle to the desired speed or the brakes have been used to slow the vehicle to the desired speed. The accelerator pedal is moved to a first range of movement to achieve this first zone of operation.

Further movement of the pedal by the operator does not impact the speed of the vehicle so long as the pedal stays within the first range. This enables the vehicle to maintain a given speed even if the operator is not particularly good at holding the accelerator steady. The small variations in speed that are the result of the operator making slight changes to the accelerator pedal, whether consciously or unconsciously, do not occur with the present accelerator pedal. Without these small speed changes, fuel efficiency is increased.

In addition, operation of the vehicle in the first zone prevents the operator from inadvertently speeding up or slowing down while driving. The gradual increase in speed that can occur when a driver is in a hurry (or perceives himself or herself to be in a hurry) or that can occur unconsciously when faster drivers are near, are avoided, thus possibly avoiding a speeding ticket or unsafe driving practices. The first zone operates much like a cruise control, but with the driver using the accelerator pedal to maintain the vehicle's speed and permitting the driver to move the accelerator pedal without changing the vehicle speed. Control of the vehicle speed in the first zone preferably uses known cruise control devices.

A feedback system is provided to alert the drive to the fact that the automobile is being operated in the first zone. A light, gauge or other indicator may be provided on the dashboard, steering wheel, heads-up display, or other convenient location so indicate to the driver that the speed of the vehicle is being maintained by operation in the first zone. The feedback may be provided by changes in resistance or spring force on the pedal, by a detent or other physical or tactile indicator to indicate transition between zones, by a tone or other sounds to indicate transition between zones, or any other feedback means. The feedback may be provided at the transition between zones, while in the respective zone, or both.

In an alternative embodiment, one or more of the zones may be selected by the driver through a switch or other control. For example, the switch or activation control may be on the dashboard, on a steering wheel control, on a so-called instrument stalk, on a shift lever or other convenient location in the vehicle. The zone control system may be turned off and on by the switch. The switch may provide the sole means for the user to switch zones, or may be an additional means for the user to switch zones for those users who do not wish to rely solely on the pedal zone control.

In a further embodiment, the accelerator pedal has a detent position that operates the vehicle in the first zone and the driver “clicks” the pedal into the detent position for first zone operation and the pedal stays in the first zone position until farther pressed by the driver.

In a second zone of operation, the accelerator pedal is moved to a second range of movement. In the second stage, a control that is preferably a computer control provides a controlled acceleration to the vehicle to increase the speed of the vehicle gradually so long as the accelerator pedal is held in the second range. Operator movement of the pedal within the second range does not effect the controlled, gradual acceleration of the vehicle. The acceleration of the second zone preferably follows a predetermined acceleration curve designed to provide acceleration while maintaining high fuel efficiency. Each vehicle has an operating zone that is more efficient than other zones and the second zone of the present invention takes advantage of that high efficiency zone. By staying in the second zone, the driver accelerates the vehicle to a higher speed in an efficient manner so that fuel savings can be realized even while accelerating. The second mode may be referred to as the economy mode.

The second stage in particular may be used to train drivers in the most efficient acceleration practices for a vehicle. It is foreseeable to provide a training vehicle for a driver to use to experience high efficiency acceleration so that the lessons learned can be carried over to operation of a vehicle that lacks the present zone acceleration system or to use of the vehicle when the zone system is turned off. It is also contemplated to provide an add-on to a vehicle that permits the user's vehicle to provide the zone feedback and acceleration control of the present device. The add-on can be a permanent addition to the vehicle or a temporary addition, such as for training purposes. The switch noted earlier can be used to switch a vehicle to a fuel efficiency training mode, and then permit the vehicle operation to be returned to normal after the training with the expectation that the drive has learned to drive the vehicle in a more fuel efficient manner.

It is contemplated to provide a system that includes only the fuel efficient acceleration zone of operation without the constant speed zone of operation. In other words, a system that includes the so-called second zone without a first zone.

The second zone of operation is indicated to the driver by an increase in pedal resistance compared to the pedal resistance of the first zone, and preferably by a steep enough increase in resistance so that it is noticeable to the driver. The physical, visual, audible and other indicators noted above may be used to indicate to the driver that the vehicle is operating in the second zone. A second detent may be provided on the pedal to permit the driver to move the accelerator pedal to the second detent position to achieve second zone operation.

In a third stage of operation, the accelerator pedal is moved to a third range of movement. In the third range, the accelerator operates normally, so that movements of the pedal by the operator translate into acceleration or deceleration of the vehicle. This normal mode of operation may also be referred to as a demand mode. The driver or operator of the vehicle operates the vehicle in the traditional manner, but may return to one of the more fuel efficient operating zones by decreasing pressure on the pedal until another zone of movement is reached, or other indicator indicates that the first or second zone has been reached. Movement to and from the third range of movement may be indicated by a change in resistance on the pedal, a detent, an audible or visual indicator, or other indicator. A switch may be provided to permit the vehicle to remain in the normal operating zone, or to be provide the two or three zone control described above.

### BRIEF DESCRIPTION OF THE DRAWINGS

FIG. 1 is a diagram of an accelerator pedal for an automobile or truck showing the zones of motion that correspond to the operating zones according to the principles of the present invention;

FIG. 2 is a block diagram of an accelerator control and accelerator pedal of the present invention;

FIG. 3 is graph showing different resistance forces of the pedal for different zones;

FIG. 4 is a graph showing a comparison of a normal acceleration curve with an acceleration curve according to the present method for optimized fuel efficiency;

FIG. 5 is a schematic diagram of a dashboard display to indicate zones of operation; and

FIG. 6 is a perspective view of an indicator for the zones of operation for the rear of a vehicle.

### DETAILED DESCRIPTION OF THE PREFERRED EMBODIMENTS

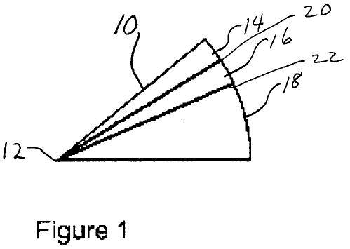

In FIG. 1, an accelerator pedal 10 for an automobile or truck is schematically shown. The accelerator pedal 10 is pivotally mounted in a vehicle (not shown) according to known mounting methods for movement about a pivot point 12. The illustrated accelerator pedal 10 has three zones of movement, a first zone 14, a second zone 16 and a third zone 18.

The accelerator pedal 10 is one example of an acceleration control according to the present invention provides an accelerator control for an automobile. The invention may also be used on a truck, van, motorcycle, or other motorized vehicle. The invention may be used on a gasoline powered vehicle, diesel powered vehicle, natural gas powered vehicle, electric vehicle, hybrid vehicle or other power source. The accelerator of the vehicle, whether it is a pedal or hand grip or other accelerator control, has at least two zones of operation, and preferably three zones. The operating zones of the preferred embodiment include a maintain speed zone in zone 14, a gradual acceleration zone in zone 16, and a normal zone in zone 18. Four or more zones of operation are also possible.

The zones of operation 14, 16 and 18 may be indicated to the operator of the vehicle by a change in resistance of the accelerator, by a detent or other physical indicator, by an audible indicator, by a visual indicator or by other indicating means. For example, the pressing force on the accelerator pedal of the vehicle may have distinct different levels to indicate the operating stage or zone of the vehicle. The first zone may be characterized by a slight pressing force, the second zone by a greater, but not too great, pressing force, and the third zone by yet a greater pressing force. The pressing force of the three zones is preferably different enough to permit the user to readily distinguish the zones from one another at transition positions 20 and 22. Physical or tactile detents or audible clicks or tones may be provided as the operator changes from one zone to another, for example at the transition positions 20 and 22 in the movement of the accelerator pedal 10.

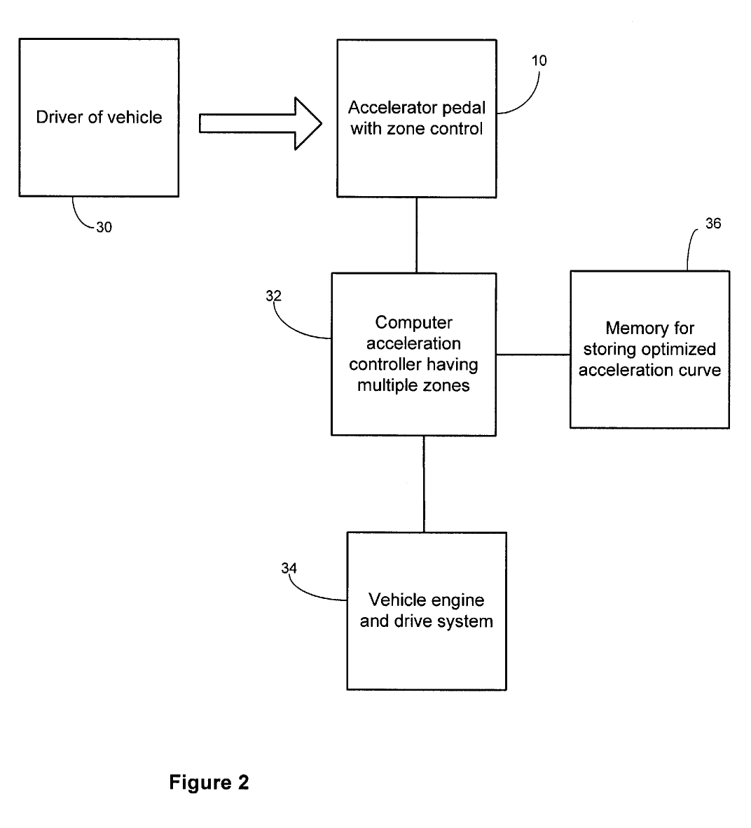

A system is shown in FIG. 2 wherein the driver 30 of a vehicle operates the accelerator pedal 10 that has zone control. The accelerator pedal 10 is linked to a computer accelerator controller 32 which has multiple control zones. The controller 32 is connected to the vehicle engine and drive system 34 so that the controller may regulate the operation of the motor and drive train for accelerating or decelerating the vehicle. The controller 32 is linked to a memory 36 for storing one or more optimized acceleration curves for the vehicle.

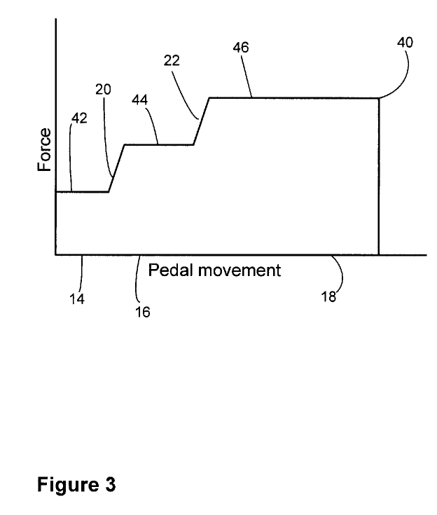

Referring to FIG. 3, a graph 40 of the force changes over pedal movement is shown. The first zone 14 is apparent to the driver by a first pressing force 42 to permit pedal movement. The second zone 16 is apparent to the driver by a second, higher force 44 for pedal movement. The third zone 18 is apparent to the driver by a third, higher yet force 46. The transition positions 20 and 22 are apparent to the driver by the sharp increase if pressing on the pedal (or decrease if letting up on the accelerator) of the pedal movement force.

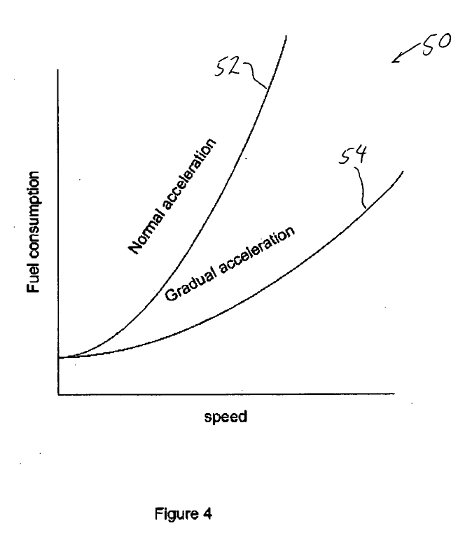

In FIG. 4, a fuel consumption graph 50 includes a curve 52 showing fuel consumption for normal operation of the vehicle. By operating the vehicle using gradual acceleration, the fuel consumption is decreased significantly as shown by curve 54. The present invention enables to driver to operate the vehicle in the gradual acceleration, fuel saving mode easily by providing tactile feedback to the driver at the accelerator pedal.

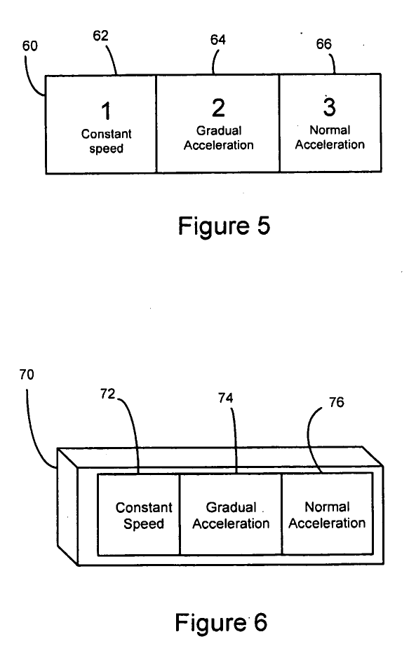

As shown in FIG. 5, the user's ability to distinguish the zones may be aided by a visual display, for example indicator lights 60 on the dashboard of the vehicle. The indicator lights 60 includes a first indicator portion 62 to indicate a first zone, a second indicator zone 64 to indicate a second zone of operation, and a third indicator portion 66 to indicate the third zone of operation. Each indicator zone 62, 64 and 66 lights up to indicate the zone of operation as controlled by the accelerator. The indicator lights on the dashboard may change to different colors, shapes, and/or positions to indicate the operating zone to the driver. The visual display may be provided on a heads up display, or on some other display location. The indicator may be provided by a gauge or other analog or digital display to show the zone at which the accelerator pedal is being operated.

The drivers of other vehicles may wish to know that the present vehicle is being operated in the operating zones, particularly drivers of vehicles following the present vehicle. As such, an indicator light 70 is preferably provided on a rear of the present vehicle to indicate at least one of the zones of operation. As shown in FIG. 6, the indicator light 70 includes three lights to indicate the three zones of operation, the first zone 72, the second zone 74 and the third zone 76. This is particularly important to drivers behind the vehicle that is operating in zone two, or gradual acceleration mode. Such an indicator light alerts the driver behind that a slow acceleration will occur due to operation in the economy mode.

The present system may be provided as a retrofit kit for installation on existing vehicles. A fuel savings can be accomplished without requiring purchase of a new vehicle. The system may also be installed as factory equipment on new vehicles.

A method of operating a vehicle is provided including providing multiple modes of operation wherein one of the modes of operation is a gradual, computer controlled acceleration for increased fuel savings and another mode is normal operation. A mode of operation wherein the driver moves the accelerator pedal to a range of motion that maintains a constant speed even if the driver moves the accelerator within that zone is also provided in some embodiments.

The present zone control having two, three or more zones may be used for remote control vehicles so that remote operators may more easily control the speed of the vehicle. Such remote control vehicles may include radio-controlled vehicles, semi-autonomously operating vehicles, and the like. A remotely controlled vehicle can thereby maintain speed or achieve a gradual fuel saving acceleration if desired, so as to increase range, for instance.

Although other modifications and changes may be suggested by those skilled in the art, it is the intention of the inventors to embody within the patent warranted hereon all changes and modifications as reasonably and properly come within the scope of their contribution to the art.

I claim:

1. An accelerator control for a vehicle, comprising:
a user operated control for a vehicle;
a feedback apparatus associated with said user operated control, said feedback apparatus defining a plurality of zones of operation of said user operated control, each of said plurality of zones corresponding to a different level of fuel usage of the vehicle; and
a computer accelerator control connected to control operation of the vehicle, one of said plurality of zones of said feedback apparatus corresponding to operation of the vehicle under control of said computer accelerator control.

2. An accelerator control as claimed in claim 1, wherein said feedback apparatus defines three zones of operation of said user operated control.

3. An accelerator control as claimed in claim 1, wherein said user operated control is operable over a range of motion, and wherein said feedback apparatus defines a plurality of zones of motion of said user operated control corresponding to zones of operation of the vehicle, movement of the user operated control within said zones of motion maintains operation of the vehicle within a corresponding zone of operation.

4. An accelerator control as claimed in claim 1, wherein said computer accelerator control controls operation of the vehicle to maintain a predetermined speed of the vehicle when said user operated control is in a first zone of movement as indicated by said feedback apparatus, said computer control being operable to maintain the predetermined speed regardless of movement of said user operated control so long as said user operated control remains in said first zone of movement.

5. An accelerator control as claimed in claim 1, wherein said feedback apparatus defines a first zone of movement for said user operated control in which a predetermined speed of the vehicle is maintained;
said feedback apparatus defining a second zone of movement of said user operated control in which acceleration of the vehicle is controlled for gradual acceleration at reduced fuel consumption as compared to normal operation; and
said feedback apparatus defining a third zone of movement of said user operated control in which operation of the vehicle is normal and acceleration is controlled by movement of said user operated control.

6. An accelerator control as claimed in claim 1, wherein said feedback apparatus includes detents at a plurality of positions of said user operated control to provide tactile information to the user when said user operated control is moved to said plurality of positions, said detents defining a range of motion of said user operated control between said detents.

7. A method of operating a vehicle, comprising the steps of:
operating an acceleration control in a first zone of operation, said first zone of operation maintaining the vehicle at a substantially constant speed;
operating the acceleration control in a second zone of operation, said second zone of operation increasing speed of the vehicle at a gradual rate according to a predetermined acceleration curve;
operating the acceleration control in a third zone of operation, said third zone of operation providing normal operation of the vehicle including acceleration or deceleration as a direct result of movement of the acceleration control; and
sensing a tactile sensation at each transition between any of said first and second and third zones of operation.

8. A method as claimed in claim 7, wherein said tactile sensation includes a difference in force required for movement of the acceleration control.

9. A method as claimed in claim 7, wherein said tactile sensation includes a detent.
